(19) United States
(12) Patent Application Publication
(10) Pub. No.: US 2004/0237741 A1
(43) Pub. Date: Dec. 2, 2004

(54) Blade assembly for food slicing device

(75) Inventors: Jerry W. Stinnett, Fort Wayne, IN (US); Rich Carias, Fort Wayne, IN (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: LINCOLN FOODSERVICE PRODUCTS, INC.

(21) Appl. No.: 10/449,959

(22) Filed: May 30, 2003

(51) Int. Cl. B26D 7/06

(52) U.S. Cl. 83/425.3

(57) ABSTRACT

A blade assembly having blades, side members, urging members, and a coating is provided. The blades have a retaining member disposed at each end. The side members have slots and a pocket. The blades are disposed in the slots so that the retaining members are received by the pocket. The urging member urges the side members away from one another so that the retaining members abut the pockets and induce a selected tension to the blades. The coating covers one or more areas of the blade assembly to increase the ease of cleaning, protect the blade assembly component, and/or prevent the urging member from loosening.

### BACKGROUND OF THE INVENTION

1. Field of the Invention

The present disclosure is related to a food slicing device. More particularly, the present disclosure is related to a blade assembly for a food slicing device.

2. Description of Related Art

Various devices have been proposed to slice food articles. One common type of food slicing device has a frame with a number of spaced stationary blades disposed thereon. A pushing device is slideably attached to the frame and allows the user to push a food article through the blades to perform the slicing operation.

In many prior devices, the blades have been formed as an integral part of the frame. This type of device has been found undesirable. For example, this type of device requires the user to move the entire device to a cleaning station after use. Further, once the blades in this type of device have become dull, the entire device must be replaced.

Some prior devices have resolved these issues by allowing the blades to be removed from the frame. However, these devices have also been found undesirable. For example, removing the blades can create safety issues when handling a plurality of loose blades.

In addition, the tension on the blades after they have been installed in the frame can be an important factor in maximizing the life expectancy of the blades. Blades that have a tension that is above or below the recommended tension can fail sooner than expected.

Accordingly, there is a continuing need in the food slicing art for devices that resolve one or more of the aforementioned deficiencies and problems in the art. Moreover, there is a continuing need in the food slicing art for blade assemblies that can be easily removed from the frame for cleaning without affecting the tension of the blades.

### SUMMARY OF THE INVENTION

A blade assembly for use with a food slicing device is provided. The assembly includes blades, side members, urging members, and a coating. The blades have a retaining member disposed at each end. The side members have slots and a pocket. The blades are disposed in the slots so that the retaining members are received by the pocket. The urging member urges the side members away from one another so that the retaining members abut the pockets and induce a selected tension to the blades. The coating covers one or more areas of the blade assembly to increase the ease of cleaning, protect the blade assembly component, and/or prevent the urging member from loosening.

A blade assembly including a first side member, a second side member, blades, an urging member, and a coating is also provided. The blades engage a portion of each of the first and second side members. The urging member urges the first and second side members from one another to induce a selected tension in the blades. The coating is disposed on the first and second side members, the portion, and the urging member.

A blade assembly is provided that includes first and second side members, blades, first and second rods, and a coating. The first side member has a first pocket and a first plurality of slots, while the second side member has a second pocket and a second plurality of slots. The blades are disposed in the first and second plurality of slots so that a portion of the blades abuts an edge of the first and second pockets. The first rod is engaged to the first and second side members by a first threaded member, while the second rod is engaged to the first and second side members by a second threaded member. The threaded members are configured to induce a selected tension in the blades by urging the members away from one another. The coating is disposed over the pockets, the slots, and the threaded members.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a perspective view of an exemplary embodiment of a food slicing device;

FIG. 2 is a perspective view of an exemplary embodiment of a blade assembly for use with the food slicing device of FIG. 1;

FIG. 3 is a perspective view of the blade assembly of FIG. 2 without a protective coating;

FIG. 4 is a top view of a side member of FIG. 3;

FIG. 5 is a front view of an alternate exemplary embodiment of a blade assembly without a protective coating;

FIG. 6 is a side view of the blade assembly of FIG. 5; and

FIG. 7 is an end view of the blade assembly of FIG. 5.

### DETAILED DESCRIPTION OF THE INVENTION

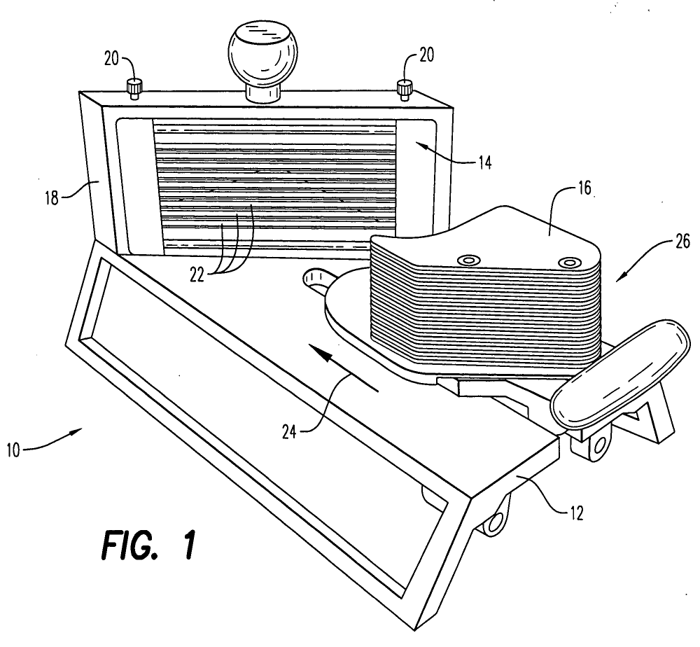

Referring to the drawings and in particular to FIG. 1, an exemplary embodiment of a food slicing device 10 is illustrated. Device 10 has a base 12, a blade assembly 14, and a pusher 16. Base 12 has a frame 18 for removably connecting blade assembly 14 to base 12. Blade assembly 14 can be removably secured in device 10 by way of one or more thumbscrews 20.

Blade assembly 14 includes a plurality of blades 22 disposed therein. Pusher 16 is disposed on base 12 for movement with respect to blade assembly 14 in a cutting direction 24 between a first position 26 and a second position (not shown). Pusher 16 is remote from blade assembly 14 when in first position 26, but is proximate the blade assembly when in the second position.

In use, pusher 16 is moved to first position 26 so that articles of food (not shown) such as fruit, vegetables, bread, pasta, and others can be placed between the pusher and blade assembly 14. Pusher 16 is then used to urge the food in cutting direction 24 towards and through blades 22 and, thus, to slice the food.

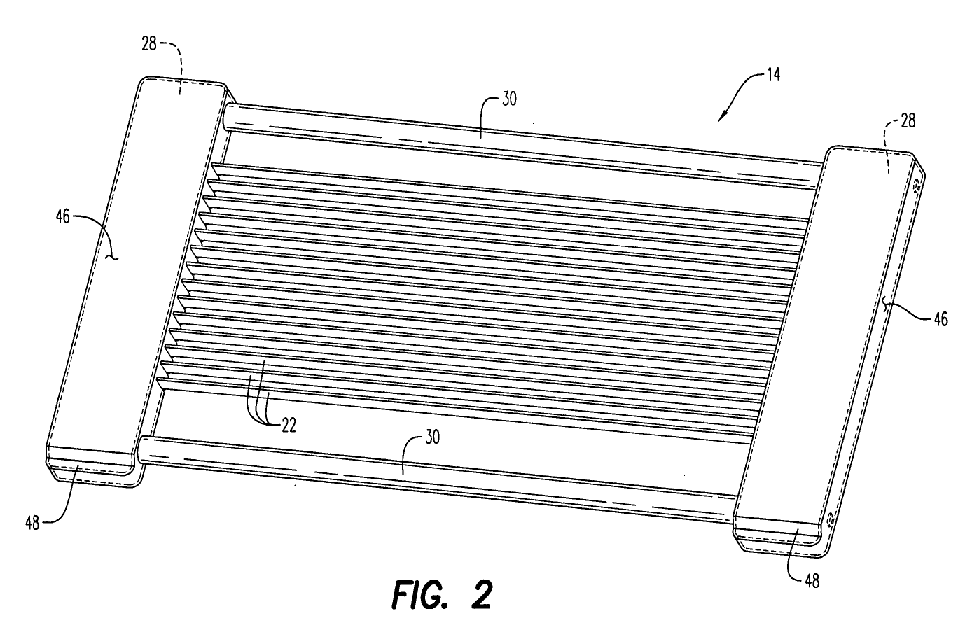

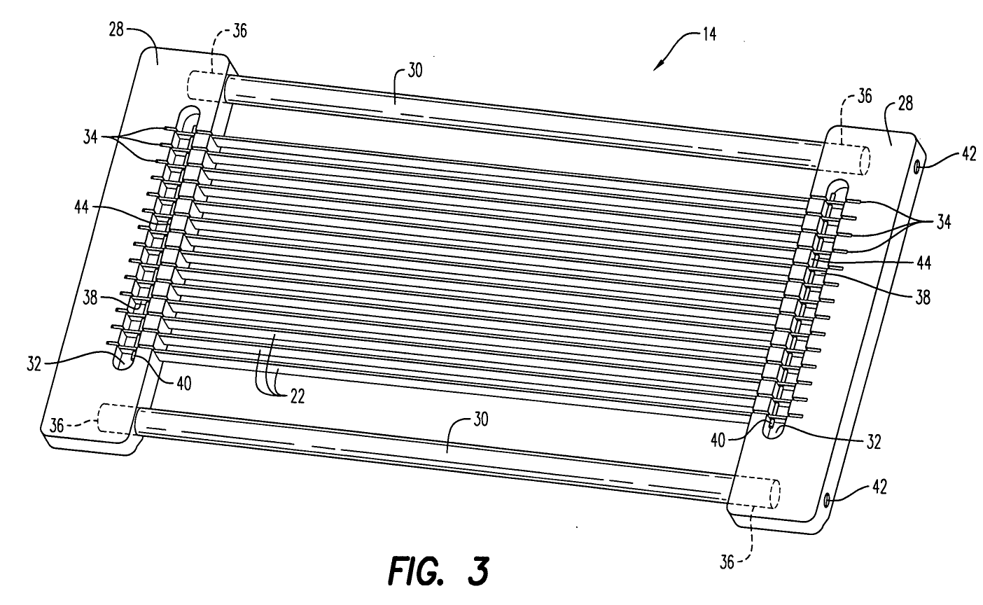

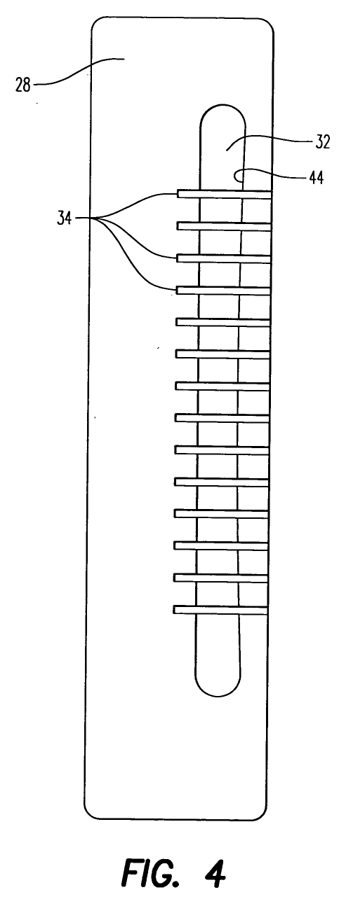

For purposes of clarity, blade assembly 14 is described with simultaneous reference to FIGS. 2-4, where the blade assembly is illustrated in FIGS. 3 and 4 without the coating illustrated in FIG. 2.

Blade assembly 14 includes blades 22 secured by a pair of side members 28 and a pair of rods 30. Rods 30 are configured to urge side members 28 from one another. Specifically, each side member 28 has a pocket 32, a plurality of blade receiving slots 34, and a pair of openings 36 formed therein.

Blades 22 are inserted in slots 34 such that tips 38 of the blades are received in pockets 32. Tips 38 include a hole (not shown) for receiving a securing pin 40. Pins 40 are inserted through the hole in blades 22 so that the pins are captured in pockets 32, respectively.

Rods 30 are inserted into openings 36. A screw 42 is threadably engaged through side member 28 with each rod 30 so that rotation of the screw urges the side members apart. As side members 28 are spread apart by rotation of screw 42, tips 38 of blades 22 slide in slots 34 until pins 40 abut with an inner edge 44 of pocket 32. In this manner, screw 42 can be adjusted until a selected tension on blades 22 is achieved. Accordingly, rods 30 are configured to urge side members 28 from one another so that pins 40 abut edge 44 of pockets 32 and, thus, induce a selected tension to blades 22.

In a preferred embodiment, side members 28 and/or pins 40 can act as a spring member to aid in maintaining the selected tension on blades 22. For example, inner edge 44 of pockets 32 can have an arcuate curvature as illustrated in FIG. 4. Again, screws 42 are adjusted until pins 40 abut with curved inner edge 44 of pocket 32. Continued tightening of screws 42 can cause pins 40 to elastically deflect and, thus, to act as a spring member to maintain the selected tension on blades 22.

It has been found that the various components of prior slicing devices, such as the blade receiving slots, collected food during use, which increased the difficulty in cleaning the device. It has also been found that the tension adjusting screws of prior slicing devices have been prone to loosening during use, which decreased the tension on the blades and decreased the life of the blades.

Advantageously, blade assembly 14 includes a coating 46 as seen in FIG. 2. It has been determined that coating 46 can be used to increase the ease with which blade assembly 14 is cleaned, prevent movement of screws 42, and protect various portions of the blade assembly from corrosive and/or acidic agents.

Coating 46 seals pocket 32, slots 34, and openings 36 in side members 28. Thus, coating 46 prevents food and other debris from collecting in these small spaces, which increases the ease with which blade assembly 14 can be cleaned as compared to prior devices that do not prevent collection of food particles.

Coating 46 can also be adapted to cover screws 42, which can prevent the screws from backing-out or loosening during use of device 10. Further, it has been found that covering screws 42 with coating 46 can prevent inadvertent adjustment of the tension of blades 22.

Also, coating 46 can be used protect various portions of blade assembly 14 from corrosive and/or acidic agents and, thus, has been found to further reduce the cost of materials of the blade assembly. For example, rods 30 are formed of a material capable of withstanding the mechanical stresses placed thereon, as well as being capable of withstanding the corrosive and/or acidic cleaning agents and foods that are commonly used with blade assembly 14, such as stainless steel. However, coating 46 allows side members 28 and pins 40 to be formed of a material capable of withstanding only the mechanical stresses placed thereon. Since coating 46 protects side members 28 and pins 40 from the deleterious effects of such cleaning agents and foods, the side members and pins can be formed of materials, such as aluminum. Thus, all exposed surfaces of blade assembly 14 are formed of corrosion resistant materials, namely stainless steel rods 30 and plastic covered side members 28. Hence, blade assembly 14 is totally corrosion resistant.

It is also contemplated by the present invention for coating 46 to cover rods 30. In this embodiment, rods 30 need only be formed of a material capable of withstanding the mechanical stresses placed thereon, such as aluminum.

Blade assembly 14 can include one or more guides 48 formed in coating 46. Guides 48 can be used to removably secure blade assembly in frame 18. In addition, guides 48 can be configured to ensure blade assembly 14 is inserted into slicing device 10 with a desired orientation. By way of example, guides 48 can be one or more keyways formed in coating 46.

Blade assembly 14 can be provided with coating 46 by any known method. For example, side members 28 of blade assembly 14 can be dipped into or sprayed with coating 46. Alternately, coating 46 can be over-molded onto blade assembly 14.

Accordingly, blade assembly 14 provides a factory set tension for blades 22 that resists loosening. Moreover, blade assembly 14 is a sealed assembly that can be easily removed from base 12. This combination of features has been found to offer an easier and safer to clean blade assembly 14 than previously available.

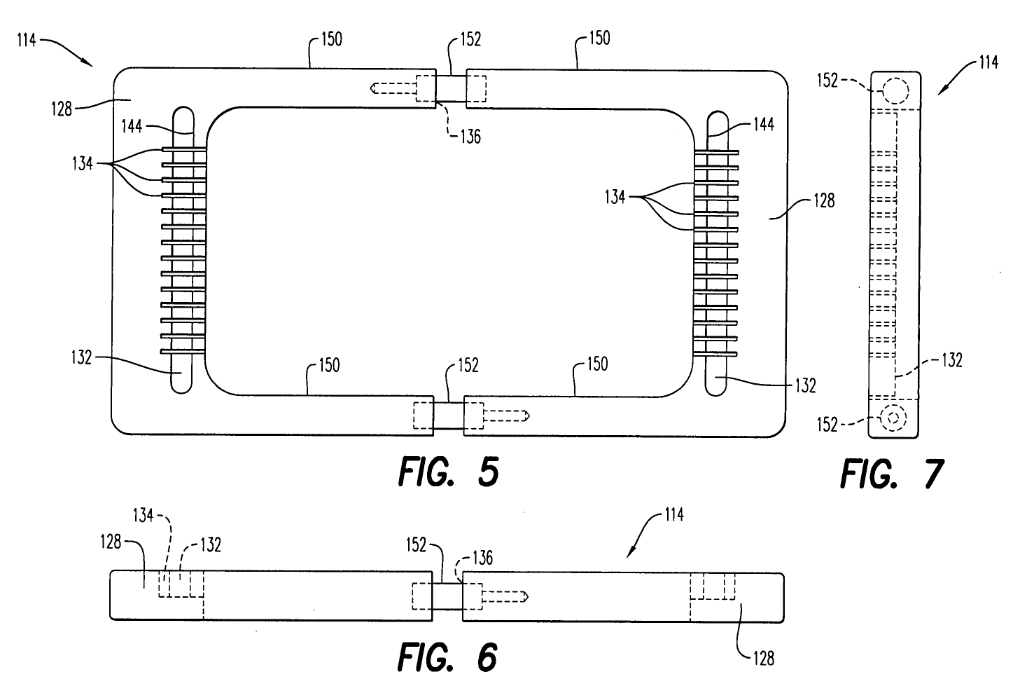

An alternate exemplary embodiment of a blade assembly 114 according to the present disclosure is illustrated in FIGS. 5-7. Here, component parts performing similar and/or analogous functions are labeled in multiples of one hundred.

In this embodiment, blade assembly 114 includes side members 128 having arms 150 depending therefrom. Arms 150 have an opening 136 defined therein. In place of the rods and screws of FIGS. 1-4, blade assembly 114 has a turnbuckle 152 disposed in openings 136. During assembly, tumbuckles 152 are inserted into openings 136 and are rotated to urge side members 128 apart. As side members 128 are spread apart by rotation of tumbuckles 152, the blades (not shown) slide in slots 134 until pins (not shown) abut with an inner edge 144 of pocket 132. In this manner, tumbuckles 152 can be used to adjust the selected tension on the blade assembly's blades.

Blade assembly 114 can also include a coating (not shown) to increase the ease with which the blade assembly is cleaned, prevent movement of turnbuckles 152, and protect various portions of the blade assembly from corrosive and/or acidic agents.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that the invention will include all embodiments falling within the scope of the appended claims.

What is claimed is:

1. A blade assembly for use with a food slicing device, comprising:
a plurality of blades each having a retaining member disposed at each end;
a pair of side members each having a plurality of slots and a pocket, each of said blades are disposed in a respective one of said slots so that said retaining members are received by said pocket;
urging member for urging said side members away from one another so that said retaining members abut said pockets to induce a selected tension to said blades; and
a coating disposed on said side members, said coating covering an area selected from the group consisting of said slots, said pocket, said retaining member, a portion of said blades, said urging member, and any combination of the foregoing.

2. The blade assembly as in claim 1, wherein said retaining member comprises a hole defined in said blades and a pin disposed through said hole of each of said blades.

3. The blade assembly as in claim 1, wherein said urging member comprises a pair of tension rods secured to said side members by a threaded member such that tightening of said mechanical member urges said side members away from one another.

4. The blade assembly as in claim 1, further comprising arms depending from each of said side members.

5. The blade assembly as in claim 4, wherein said urging member comprises a turnbuckle disposed between said arms such that tightening of said turnbuckle urges said side members away from one another.

6. The blade assembly as in claim 1, further comprising a guide formed in said coating, said guide being configured to ensure that said blade assembly can be installed in said food slicing device in a predetermined orientation.

7. The blade assembly as in claim 1, wherein said coating prevents said urging member from loosing.

8. The blade assembly as in claim 1, wherein said coating prevents food from collecting in said slots, said pocket, said retaining member, said urging member, or any combination of the foregoing.

9. The blade assembly as in claim 1, wherein said pockets comprise a curved edge that abut said retaining members so that said retaining members and/or said pair of side members act as a spring member to maintain said selected tension.

10. A blade assembly for use with a food slicing device, comprising:
a first side member;
a second side member;
a plurality of blades engaging a portion of each of said first and second side members;
urging member for urging said first and second side members from one another to induce a selected tension in said plurality of blades; and
a coating disposed on said portion, said urging member, and/or said first and second side members.

11. The blade assembly as in claim 10, wherein said coating prevents food from collecting in said portion and said urging member.

12. The blade assembly as in claim 11, wherein said coating prevents said urging member from loosening from said selected tension.

13. The blade assembly as in claim 12, further comprising a guide formed in said coating for ensuring said blade assembly can be installed in said food slicing device in a predetermined orientation.

14. The blade assembly as in claim 10, wherein said urging member comprises a pair of tension rods secured to said first and second side members by a threaded member such that tightening of said threaded member urges said first and second side members away from one another.

15. The blade assembly as in claim 10, further comprising arms depending from each of said first and second side members.

16. The blade assembly as in claim 15, wherein said urging member comprises a turnbuckle disposed between said arms such that tightening of said tumbuckles urge said first and second side members away from one another.

17. A blade assembly for use with a food slicing device, comprising:
a first side member having a first pocket and a first plurality of slots defined therein;
a second side member having a second pocket and a second plurality of slots defined therein;
a plurality of blades disposed in said first and second plurality of slots so that a portion of said plurality of blades abut an edge of said first and second pockets;
a first rod engaged to said first and second side members by a first threaded member;
a second rod engaged to said first and second side members by a second threaded member; and
a coating disposed over said first and second pockets, said first and second plurality of slots, and said first and second threaded members, wherein said first and second threaded members are configured to induce a selected tension in said plurality of blades by urging said first and second side members from one another.

18. The blade assembly as in claim 17, wherein said edge is a curved edge.

19. The blade assembly as in claim 18, wherein said curved edge abuts said plurality of blades so that said first and second side members act as a spring member to maintain said selected tension.

20. The blade assembly as in claim 19, wherein said coating prevents said first and second threaded members from loosening from said selected tension.
